(19) United States
(12) Patent Application Publication
(10) Pub. No.: US 2008/0009288 A1
(43) Pub. Date: Jan. 10, 2008

(54) Radio Network With Parallel Transmission and a Method of Forwarding a Signal in a Radio Network

(75) Inventors: Georgios Orfanos, Aachen (DE); Jorg Habetha, Aachen (DE); Francesc Dalmases, Bellaterra- Barcelona (ES); Klaus Peter May, Aachen (DE); Begonya Otal, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,551

(22) PCT Filed: Jun. 15, 2005
(86) PCT No.: PCT/IB05/51969

§ 371 Date: Dec. 13, 2006

(30) Foreign Application Priority Data
Jun. 24, 2004 (EP) 04102939.8

(51) Int. Cl. H04Q 7/20

(52) U.S. Cl. 455/436

(57) ABSTRACT

The subnets of a radio network are separated by different scrambling codes. A signalling frame comprises information concerning the spreading code used on the neighbouring or second subnet which can therefore be reserved for a multi hop connection in the first subnet as well. Therefore, in the easiest case the forwarding device only needs to change the scrambling code of the data flow to that of the following subnet and can keep the same spreading code.

The invention relates to a communications (telephone or computer) network which uses radio as its carrier or physical layer. Networks of that kind are organized either decentralized or in subnets such as clusters, piconets or cells. In order to unify the description in the present invention the term “subnet” is used in the following. A subnet may refer to a single device and the first radio hops around that device, i.e. the hops in which the device is either sender or receiver, e.g. in case of a decentralized network, or to a group of devices in case of a cellular or cluster-based network. Neighbouring subnets (or hops in case of a decentralized network) differ from one another as regards their scrambling code. Nowadays communication networks are expanding with respect to both the number of services they offer and the covered area. In an expanded network the same scrambling code may be used in two subnets which are located apart from one another for efficient spatial re-use of the wireless medium.

A subnet is built by a group of devices such as terminals, nodes, subscribers or stations that share the same medium, i.e. the same network. For example, in a cellular radio system according to one of the standards GSM (Global System for Mobile Communication) or UMTS (Universal Mobile Telecommunications System) a central unit called base station controls the distribution of the network's resources. This base station manages the network for its range within the infrastructure.

The invention especially relates to a telephone network where certain devices act as a base station controlling one subnet and where other devices are assigned to a subnet and thus to a base station. Two devices of the same subnet may communicate alternatively

directly in an ad-hoc modus either with or without knowledge of the base station or Access Point or

in an infrastructure modus with the aid of the base station or Access Point

A device that is in the intersection of two neighbouring subnets is able to communicate in each one of the two subnets, i.e. it knows both scrambling codes and has an address in each of the two subnets. This device is called a forwarding node, bridge or gateway and is able to relay data sent by a device which is located in one subnet to a device of a neighbouring subnet. Thus a multi-hop connection can be performed where the source device belongs to a subnet that is different from the destination device's subnet. The destination subnet may either be a neighbouring subnet or a subnet that is several subnets apart. The forwarding feature enables communication between any two devices belonging to different subnets in a network as it interconnects those subnets. For doing this, a forwarder has to be able to participate in both subnets and as well as to manipulate the data stream in such a way that it is enabled to be relayed to the neighbouring subnet.

The invention especially relates to ad-hoc radio networks. In an ad-hoc network, devices access the medium and quit later on resulting in an amount of participating devices that varies in time. A known ad-hoc system for a Wireless Local Area Network (WLAN) uses the IEEE 802.11 standard protocol with CSMA/CA (Carrier Sense Medium Access with Collision Avoidance) for the MAC (Medium Access Control) and DSSS (Direct Sequence Spread Spectrum) as Spread Spectrum.

In particular, the invention relates to ad-hoc networks which are based on Code Division Multiple Access (CDMA). In a network based on CDMA, a spreading code is used to distribute the symbols or chips of a device's data stream on a bandwidth or code channel which is temporarily assigned. Several devices of one subnet may use the same channel, i.e. the same frequency or frequency band. Thus, one channel or subcarrier contains information from different sources. Based on the spreading code negotiated at the beginning of the connection the receiving device can select the information that was meant for it.

The invention also relates to a radio network using the Bluetooth standard 802.15 with FHSS (Frequency Hopping Spread Spectrum) as spread spectrum and consisting of subnets that are called piconets.

Generally, the invention relates to any radio network, in which spread spectrum techniques are used to separate parallel transmissions.

Object of the invention is to forward a signal in a radio network with parallel transmission where spread spectrum is used.

The object is solved by a radio network consisting of a plurality of devices which are grouped into at least two subnets wherein a subnet comprises at least a single device and neighbouring subnets use different scrambling codes and wherein a source device has a transmission range and sends a source signal to a destination device via more than one radio hop not being in the reception range of said source device and thus not being able to directly receive the source signal and wherein a parallel transmission occurs, wherein

one of the radio network's devices acts as a forwarding device that is able to communicate in both the subnet of the source device and a neighbouring subnet as it is aware of the scrambling codes of both subnets

the forwarding device receives the source signal sent by the source device, realizes that itself is not the intended receiver, manipulates the scrambling code of the received signal to that one of the neighbouring subnet and forwards or relays the manipulated signal to the neighbouring subnet.

The source device may be that device that originally generated the signal or an other device that itself acts as a forwarding device. The manipulated signal may either reach the destination device directly if this one is within the transmission range of the forwarding device or be forwarded by a further forwarding device. Thus a multi-hop transmission can be realized where a hop means entering another subnet, for example by adopting its scrambling code.

More than one radio hop may be required if the destination device is not in the transmission range of the source device

It is advantageous to use a spread spectrum technique for the parallel transmission that is selected from the group consisting of FHSS, DSSS, MC-CDMA, Pulse Position Modulation (PPM) and UWB.

According to two alternatives the forwarding device

reserves in the neighbouring subnet those resources, i.e. channels, on which it received the source signal in order to transmit the manipulated signal on the same resources, i.e. channels, or

chooses and reserves other resources, i.e. channels, in the neighbouring subnet than those ones used in the source subnet.

A resource, i.e. a channel or a code channel respectively, may comprise M subcarriers and K spreading codes. If the forwarding device finds out that they are idle it keeps the same resources for the manipulated signal. If at least one of the subcarriers or spreading codes is not idle or if they do not fit, for example if there is disturbance or interference, other subcarriers and/or spreading codes are used for the transmission of the manipulated signal.

According to one embodiment the forwarding device uses for the parallel transmission the same number of channels or code channels as the source device used. In this case the decoding and the encoding can be realized in an easy way. A code channel is a combination of one spreading code and a frequency channel (carrier or subcarrier). In this document the expression channel includes the expression code channel which may correspond to a sequence of subcarriers.

In case of multicarrier systems a frequency channel is divided into subcarriers, so that inside the allocated carrier also subcarriers can be allocated. Therefore, code channel relates to the carrier frequency, the spreading code/codes, the number and/or the position of subcarriers inside the carrier (channel) that are used as one transmission channel.

The devices participating in the network for the current forwarding are called source, forwarder and destination device. It is advantageous if they use a Medium Access Control protocol (MAC) that is adaptive as this one allocates resources for a transmission even if in the neighbouring subnet those resources used for the transmission of the source signal are occupied or not fitting. The adaptive Medium Access Protocol may use a binary sequence for allocating resources to a transmission wherein one bit corresponds to one code channel and the total amount of bits corresponds to the total amount of code channel and “1” stands for a valid code channel and “0” for a non valid one, i.e. an occupied or not fitting one.

According to a preferred embodiment the participating devices use an on demand mechanism such as a Request-to-Send/Clear-to-Send mechanism for negotiating and for reserving resources, i.e. bandwidth.

The radio network may e.g. be selected from the group consisting of WLAN, WPAN and UMTS.

The devices may e.g. be selected from the group consisting of cellular phone, Personal Computer, Laptop, Notebook, Personal Digital Assistant (PDA) and Consumer Electronic devices such as video cassette recorder (VCR), television (TV) or camera and peripheral devices such as hard disk, printer, Base Station or Access Point.

The object is also solved by a method of forwarding a signal in a radio network consisting of devices which are grouped into at least two subnets wherein a subnet comprises at least a single device and neighbouring subnets use different scrambling codes, wherein a source device has a transmission range and sends a source signal using part of the network's resources to a destination device via more than one radio hop, for example because the destination device is not in the transmission range of the source device and thus not being able to directly receive the source signal and wherein any form of spread spectrum is used to separate parallel transmissions, the method comprising the steps of

the source device sending a signal on a selected code channel or on selected channels by using the scrambling code of the subnet it belongs to;

a forwarding device which is located in the intersection of the source station's subnet and at least one neighbouring subnet and thus is able to communicate in both of them as it is aware of both scrambling codes used, this forwarding device receiving the source signal, realizing that itself is not the intended device, manipulating the signal in order to adopt it to the scrambling code of the neighbouring subnet and forwarding or relaying the manipulated signal to the neighbouring subnet.

By applying this method a signal can be forwarded from one subnet to another in a radio network without the need of a base station infrastructure. The forwarding device checks the destination address of the received signal and compares it with its own. In case they are different the forwarding device descrambles the signal in order to retrieve the original bit sequence or the original chips and then scrambles the pure signal again with the neighbouring subnet's scrambling code in order to send it to that subnet.

It is advantageous if the spread spectrum used for the parallel transmission is selected from a group consisting of FHSS, DSSS, MC-CDMA, PPM and UWB.

The forwarding device determines both the code channel of the source signal as well as the status of the channels in the neighbouring subnet. There are two possibilities for the transmission in the neighbouring subnet: the forwarding device alternatively

reserves in the neighbouring subnet those code channels on which it received the source signal of the source device in order to transmit the manipulated signal on the same code channels or

chooses and reserves other channels in the neighbouring subnet than those in the first subnet.

The negotiation between the source device, the forwarding device and the destination device may be based on an on demand mechanism such as a Request-to-send/ Clear-to-Send mechanism where the packets include at least information about the source's address, the intended destination's address and a proposal of which channels to use.

According to a preferred embodiment the Clear-to-Send radio signal of the forwarding device is also audible in the second subnet and comprises information concerning those channels that may perhaps be used for the transmission and devices in the second subnet which hear the Clear-to-Send signal at first will not transmit on the code channels reserved by the Clear-to-Send signal. The reserved channels may be left idle until the transmission actually begins as than it can be determined by each device listening in the medium which channels are used in fact.

The object is also solved by a device in the intersection of a first and a neighbouring subnet that is able to forward or relay to the neighbouring subnet a signal whose source is in the first subnet whereby in the two subnets a different scrambling code is used, the device comprising

means for receiving a radio source signal;

means for decoding a received radio signal which is split up by a spreading code in order to retrieve the data spectrum;

means for encoding a data spectrum by means of a spreading code in order to achieve a broad bandwidth;

means for manipulating the received signal as regards the scrambling code used and

means for sending the manipulated signal.

The means for receiving a radio signal may be an antenna which is connected to accommodate filters. The data stream generated by this means is descrambled by using the scrambling code of the source subnet in order to retrieve the original chips. Then the original signal is scrambled by using the scrambling code of the neighbouring subnet. The means for sending the manipulated signal may be an antenna.

If a spreading code is used to achieve a parallel transmission the forwarding device advantageously comprises

means for decoding a received radio signal which is split up by a spreading code in order to retrieve the data spectrum and

means for encoding a data spectrum by means of a spreading code in order to achieve a broad bandwidth.

Considering both that the subnets are separated from one another by different scrambling codes and that an adaptive Medium Access Control (MAC) protocol allocates a certain set of subcarriers and spreading codes to a transmission the implementation of the relay function is performed in a very efficient way.

The subnets are separated by different scrambling codes. A signalling frame such as the CTS signal comprises information concerning the spreading code used on the second subnet, which can therefore be reserved for the multi hop connection in the first subnet as well. The forwarder only needs to change the scrambling code of the data flow to that of the following subnet and can keep the same spreading code.

In the following, the invention will be described in further detail with reference to the accompanying drawings, wherein

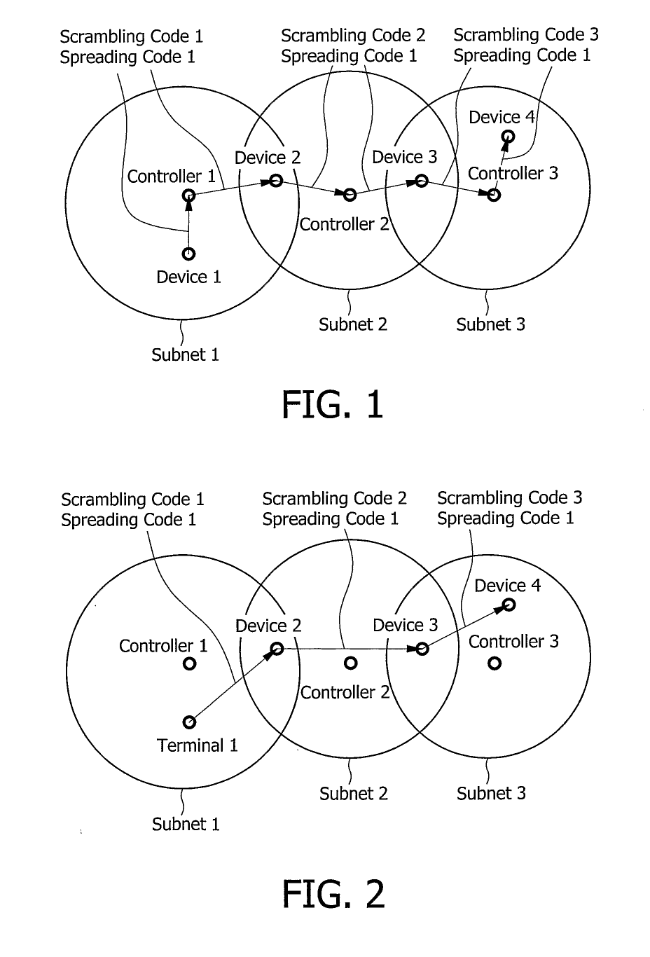

FIG. 1 shows a schematic multi-hop network with three subnets, with controllers and centralized communication;

FIG. 2 shows a schematic multi-hop network with three subnets, with controllers and decentralized or direct communication;

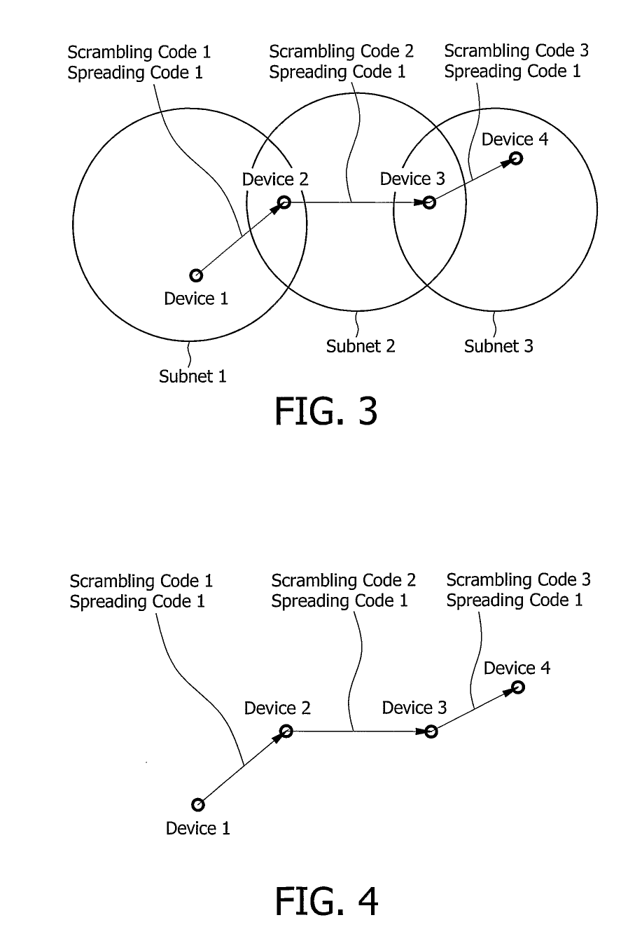

FIG. 3 shows a schematic multi-hop network with three subnets, without controllers and decentralized or direct communication;

FIG. 4 shows a schematic decentralized network with three hops/“subnets” without controllers and decentralized or direct communication;

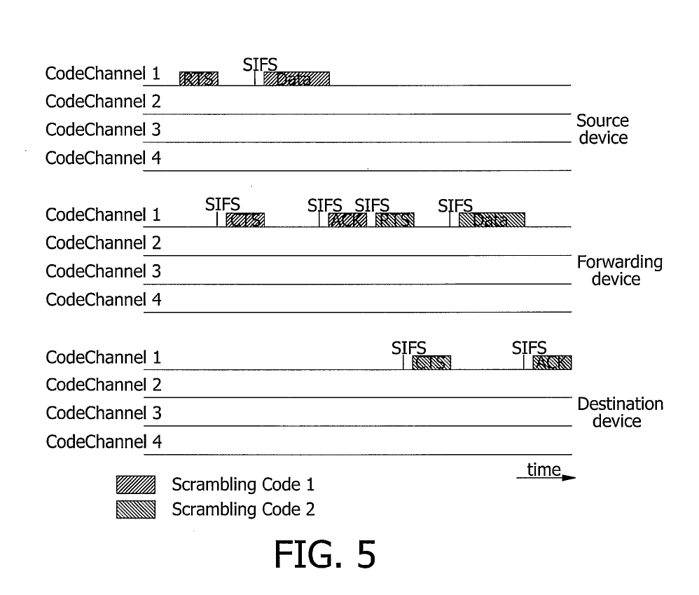

FIG. 5 shows a time diagram for the forwarding process where the spreading code is kept the same and

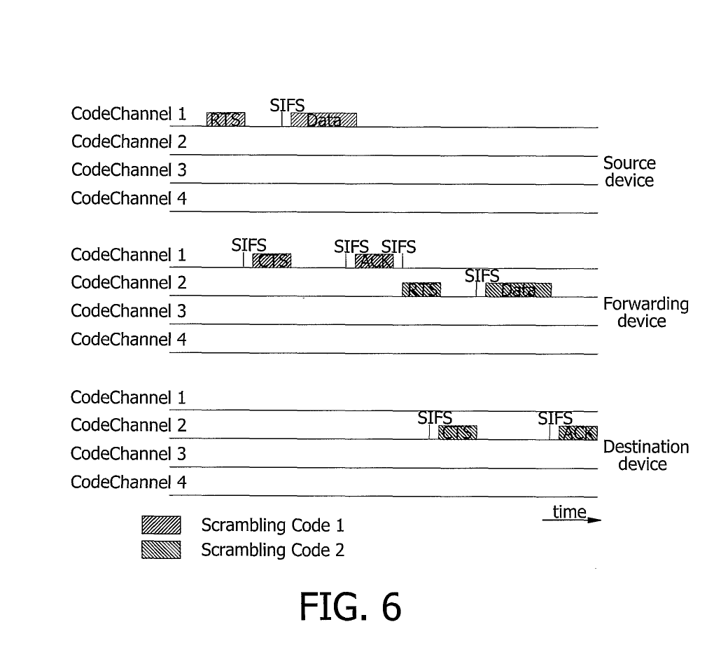

FIG. 6 shows a time diagram for the forwarding process where the spreading code is changed.

FIG. 1 shows a schematic multi-hop network with three subnets and central controllers. One controller coordinates the centralized communication within a subnet. Scrambling code 1 is assigned to the devices that share subnet 1. Similarly, scrambling code 2 is assigned to the devices that share subnet 2. Device 2 that is arranged in the intersection of two subnets 1 and 2 is able to transceive in both subnets 1 and 2 and acts as a forwarder. In this example, device 1 starts a transmission with the data being modulated by scrambling code 1 and spreading code 1. Though both devices 1 and 2 are in the transmission and reception respectively range of one another, device 1 firstly sends data to controller 1 which than relays the data stream to device 2 which in this case acts as forwarder. After verifying that spreading code 1 is not occupied in the neighbouring subnet 2, device 2 changes only the scrambling code into that one of the neighbouring subnet 2 and forwards the data to controller 2. In subnet 2 again the controller relays the data stream from device 2 to device 3 which are in the transmission and reception range of one another. Finally device 3 forwards the data stream to controller 3 which relays it to the destination device 4.

FIG. 2 shows a schematic multi-hop network with three subnets, with controllers and a decentralized or direct communication. Devices that are in the transmission range or reception range respectively of one another communicate directly bypassing the controllers who may do the signalling for the transmissions. Again, from one subnet to the next, the data stream is manipulated in such a way that it is adapted to the scrambling code of the neighbouring subnet keeping the spreading code that was assigned by the source device.

FIG. 3 shows a schematic multi-hop network with three subnets, without controllers and decentralized or direct communication. In this ad-hoc network again devices that are arranged in the intersection of two neighbouring subnets act as forwarding devices.

FIG. 4 shows a schematic decentralized network with three hops/“subnets” and decentralized or direct communication. Any device can act as forwarder for any other device in range. Again different scrambling codes are used on different hops but the spreading code may the identical for all hops of a multi hop connection.

FIG. 5 shows a time diagram for the forwarding process where the spreading code is kept the same. A code channel may comprise M subcarriers and K spreading codes. In this example the reservation mechanism used is an RTS/CTS sequence (Request-to-Send/Clear-to-Send). The CTS signal which can also be heard in a second subnet comprises information concerning the spreading code used. When the forwarding device has received the data packet it decodes it by using the scrambling code of the first subnet and encodes it by using the scrambling code of the neighbouring subnet. As can be seen in this example, the spreading codes used are idle in the neighbouring subnet and are used for the further transmission of the signal. Between the signals RTS, CTS, DATA and ACK (acknowledgement) of the IEEE 802.11 may be a SIFS (Short Interframe Signal). The reservation in the second subnet allows the forwarder to establish the resources needed for the multi-hop connection in the second subnet and to simultaneously enable a better organization of the resource allocation in the second subnet. The latter is owing to the fact that the other devices in the second subnet are now aware of which code channels are used by the multi-hop connection. This forwarding by switching the scrambling code but keeping the spreading code can be referred to as code domain forwarding.

FIG. 6 shows a time diagram for the forwarding process where the spreading code is changed as it is occupied in the next subnet or is not fitting well. In case the same set of subcarriers cannot be used in the second subnet the relay function can be realized in an efficient alternative way. Then during the RTS/CTS sequence a new set of subcarriers, a new code-channel respectively, has to be negotiated on. This forwarding by switching the scrambling code and changing the subcarriers, the code-channel respectively, used may be referred to as code and frequency domain forwarding. A fast way to choose a new set of subcarriers could be to apply a binary shift-operator to the received bit sequence which defines the subcarriers, the code-channels respectively.

1. A radio network consisting of a plurality of devices which are grouped into at least two subnets wherein a subnet comprises at least a single device and neighbouring subnets use different scrambling codes and wherein a source device has a transmission range and sends a source signal using part of the network's resources to a destination device via more than one radio hop where the destination device is not in the transmission range of said source device and thus not able to receive the source signal directly, and wherein a spread spectrum is used to separate parallel transmissions, characterized in that
one of the radio network's devices acts as a forwarding device that is able to communicate in both the subnet of the source device and a neighbouring subnet as it is aware of the scrambling codes of both subnets and
the forwarding device receives the source signal sent by the source device, realizes that itself is not the intended receiver, manipulates the scrambling code of the received signal to that one of the neighbouring subnet and forwards or relays the manipulated signal to the neighbouring subnet.

2. The radio network of claim 1, characterized in that the spread spectrum for the parallel transmission is selected from the group consisting of FHSS, DSSS, MC-CDMA, PPM and UWB.

3. The radio network of claim 1, characterized in that the forwarding device alternatively
reserves in the neighbouring subnet those resources on which it received the source signal in order to transmit the manipulated signal on the same resources or
chooses and reserves other resources in the neighbouring subnet than those ones used in the source subnet.

4. The radio network of claim 3, characterized in that the forwarding device uses the same number of channels or code channels as the source device used.

5. The radio network of claim 1, characterized in that the participating devices source, forwarder and destination use an adaptive Medium Access Control protocol (MAC) for allocating resources to a transmission.

6. The radio network of claim 5, characterized in that the adaptive Medium Access Protocol uses a binary sequence for allocating resources to a transmission.

7. The radio network of claim 7, characterized in that the participating devices use an on demand mechanism (RTS/CTS) for negotiating and for reserving resources.

8. A radio network according to claim 1, characterized in that it is selected from a group consisting of WLAN, WPAN and UMTS.

9. A radio network according to claim 1, characterized in that the devices are selected from the group consisting of cellular phone, Personal Computer, Laptop, Notebook, Personal Digital Assistant (PDA), Consumer Electronic devices such as VCR, TV or camera and peripheral devices such as hard disk, printer, Base Station or Access Point

10. A method of forwarding a signal in a radio network consisting of devices which are grouped into at least two subnets wherein a subnet comprises at least a single device and neighbouring subnets use different scrambling codes, wherein a source device has a transmission range and sends a source signal using part of the network's resources to a destination device via more than one radio hop where the destination device is not in the transmission range of the source device and thus not able to directly receive the source signal and wherein any form of spread spectrum is used to separate parallel transmissions, characterized by the steps of
the source device sending a signal on a selected code channel or on selected code channels by using the scrambling code of the subnet it belongs to;
a forwarding device which is located in the intersection of the source station's subnet and a neighbouring subnet and thus is able to communicate in both of them as it is aware of both scrambling codes used, this forwarding device receiving the source signal, realizing that itself is not the intended receiver, manipulating the signal in order to adopt it to the scrambling code of the neighbouring subnet and forwarding or relaying the manipulated signal to the neighbouring subnet.

11. The method of claim 10, characterized in that the spread spectrum used for the parallel transmission is selected from a group consisting of FHSS, DSSS, MC-CDMA, PPM and UWB.

12. The method of claim 10, characterized in that the forwarding device alternatively
reserves in the neighbouring subnet those code channels on which it received the source signal of the source device in order to transmit the manipulated signal on the same code channels or
chooses and reserves other code channels in the neighbouring subnet than those ones in the first subnet.

13. The method of claim 10, characterized in that the negotiation between the source device, the forwarding device and the destination device is based on an on demand (RTS/CTS) mechanism.

14. The method of claim 13, characterized in that the Clear-to-Send (CTS) radio signal of the forwarding device is audible in the second subnet and comprises information concerning those code channels that may perhaps be used for the transmission and that devices in the second subnet which hear the Clear-to-Send signal at first will not transmit on those code channels reserved by the Clear-to-Send signal.

15. A device in the intersection of a first and a neighbouring subnet that is able to forward or relay to the neighbouring subnet a signal whose source is in the first subnet whereby in the two subnets a different scrambling code is used, characterized in that the device comprises
means for receiving a radio source signal;
means for decoding a received radio signal which is split up by a spreading code in order to retrieve the data spectrum;
means for encoding a data spectrum by means of a spreading code in order to achieve a broad bandwidth;
means for manipulating the received signal as regards the scrambling code used and
means for sending the manipulated signal.
